(19) United States
(12) Patent Application Publication
(10) Pub. No.: US 2020/0082375 A1
(43) Pub. Date: Mar. 12, 2020

(54) SYSTEM AND METHOD FOR PEER-TO-PEER PAYMENTS

(71) Applicants: Ankush Singhal, Dublin, CA (US); Vijayalakshmi Gowri Shanker, Fremont, CA (US); Rajib Bhakat, San Ramon, CA (US)

(72) Inventors: Ankush Singhal, Dublin, CA (US); Vijayalakshmi Gowri Shanker, Fremont, CA (US); Rajib Bhakat, San Ramon, CA (US)

(21) Appl. No.: 16/129,184

(22) Filed: Sep. 12, 2018

(51) Int. Cl. G06Q 20/22; G06Q 20/36; G06Q 20/34

(52) U.S. Cl. CPC G06Q 20/223; G06Q 20/351; G06Q 20/36

(57) ABSTRACT

A computer-implemented method or a system including a processor and a memory may include instructions for receiving instructions from a sender computing system to facilitate sending a payment to a receiver computing system. The instructions may include a value and identifying information for both the sender computer system and the receiver computer system. The sender computer system may be indicated in financial institution system account data at a financial institution system and the receiver computer system may not be indicated in the financial institution system account data at the financial institution system. Further, no peer-to-peer payment system may include both the sender computer system and the receiver computer system. The memory may also include instructions for provisioning a virtual debit card including identifying information for the receiver computer system, adding the value to the virtual debit card, and sending the virtual debit card to the receiver computer system.

### BACKGROUND

Various platforms facilitate peer-to-peer electronic payments. However, these systems require that at least one party, typically the sender, have an account a financial institution. Too, most systems require that both the sender and the recipient have an account with the same financial institution or at least the same platform in order to complete the payment. Thus, many potential users are left out of most peer-to-peer payment systems because the sender and receiver do not meet account criteria to complete a payment within the platform.

### SUMMARY

The following presents a simplified summary of the present disclosure in order to provide a basic understanding of some aspects of the disclosure. This summary is not an extensive overview. It is not intended to identify key or critical elements of the disclosure or to delineate its scope. The following summary merely presents some concepts in a simplified form as a prelude to the more detailed description provided below.

In some embodiments, a computer-implemented method or a system including a processor and a memory may include instructions for receiving instructions from a sender computing system to facilitate sending a payment to a receiver computing system. The instructions may include a value and identifying information for both the sender computer system and the receiver computer system. The sender computer system may be indicated in financial institution system account data at a financial institution system and the receiver computer system may not be indicated in the financial institution system account data at the financial institution system. Further, no peer-to-peer payment system may include both the sender computer system and the receiver computer system. The memory may also include instructions for provisioning a virtual debit card including identifying information for the receiver computer system, adding the value to the virtual debit card, and sending the virtual debit card to the receiver computer system.

### BRIEF DESCRIPTION OF THE FIGURES

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 shows an illustration of an exemplary peer-to-peer (P2P) payment system;

FIG. 2A shows a first view of an exemplary payment device for use with the system of FIG. 1;

FIG. 2B shows a second view of an exemplary payment device for use with the system of FIG. 1;

FIG. 3 is a flowchart of a method for facilitating P2P payments; and

FIG. 4 shows an exemplary computing device that may be physically configured to execute the methods and include the various components described herein.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, components, or devices. Accordingly, the present invention may take the form of an entirely hardware embodiment, an entirely software embodiment, or an embodiment combining software and hardware aspects. The following detailed description is, therefore, not to be taken in a limiting sense.

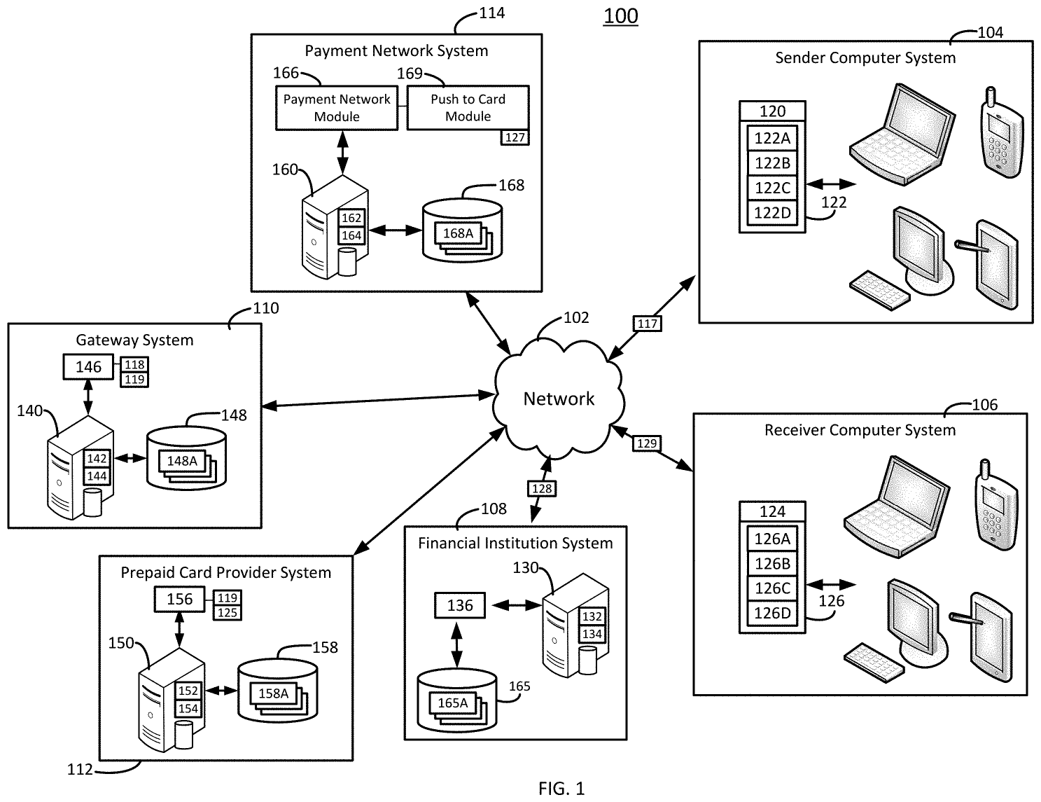

FIG. 1 generally illustrates one embodiment of a P2P payment system 100 for facilitating payments between individuals and merchants. The system 100 may include a computer network 102 that links one or more systems and computer components. In some embodiments, the system 100 includes a sender computer system 104, a receiver computer system 106, a financial institution system 108, a gateway system 110, a prepaid card provider system 112, and a payment network system 114.

The network 102 may be described variously as a communication link, computer network, internet connection, etc. The system 100 may include various software or computer-executable instructions or components stored on tangible computer memories and specialized hardware components or modules that employ the software and instructions to facilitate P2P payments.

The various modules may be implemented as computer-readable storage memories containing computer-readable instructions (i.e., software) for execution by one or more processors of the system 100 within a specialized or unique computing device. The modules may perform the various tasks, methods, blocks, sub-modules, etc., as described herein. The system 100 may also include both hardware and software applications, as well as various data communications channels for communicating data between the various specialized and unique hardware and software components.

Networks are commonly thought to comprise the interconnection and interoperation of hardware, data, and other entities. A computer network, or data network, is a digital telecommunications network which allows nodes to share resources. In computer networks, computing devices exchange data with each other using connections, i.e., data links, between nodes. Hardware networks, for example, may include clients, servers, and intermediary nodes in a graph topology. In a similar fashion, data networks may include data nodes in a graph topology where each node includes related or linked information, software methods, and other data. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications or data network. A computer, other device, set of related data, program, or combination thereof that facilitates, processes information and requests, and/or furthers the passage of information from a source user to a destination user is commonly referred to as a “node.” Networks generally facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

A sender computer system 104 may include a processor 120 and memory 122. The sender computer system 104 may include a server, a mobile computing device, a smartphone, a tablet computer, a Wi-Fi-enabled device or other personal computing device capable of wireless or wired communication, a thin client, or other known type of computing device. The memory 122 may include various modules including instructions that, when executed by the processor 120 control the functions of the sender computer system generally and integrate the sender computer system 104 into the system 100 in particular. For example, some modules may include a sender operating system 122A, a sender browser module 122B, a sender communication module 122C, and a sender electronic wallet module 122D. In some embodiments, the sender electronic wallet module 122D and its functions described herein may be incorporated as one or more modules of the sender computer system 104. In other embodiments, the sender electronic wallet module 122D and its functions described herein may be incorporated as one or more sub-modules of the payment network system 114.

In some embodiments, a module of the sender computer system 104 may pass user payment data to other components of the system 100 to facilitate P2P payments. For example, one or more of the sender operating system 122A, sender browser module 122B, sender communication module 122C, and sender electronic wallet module 122D may pass data to a financial institution system 108, the gateway system 110, and/or to the payment network system 114 to facilitate a P2P payment transaction between the sender computer system 104 and the receiver computer system 106. Data passed from the sender computer system 104 to other components of the system may include a sender name, a sender amount, financial institution system account data 165A, sender and/or receiver identification data, and other data. The sender computer system may be indicated within the account data 165A of the financial institution system 108.

A receiver computer system 106 may include a processor 124 and memory 126. The receiver computer system 106 may include a server, a mobile computing device, a smartphone, a tablet computer, a Wi-Fi-enabled device or other personal computing device capable of wireless or wired communication, a thin client, or other known type of computing device. The memory 126 may include various modules including instructions that, when executed by the processor 124 control the functions of the receiver computer system generally and integrate the receiver computer system 106 into the system 100 in particular. For example, some modules may include a receiver operating system 126A, a receiver browser module 126B, a receiver communication module 122C, and a receiver electronic wallet module 122D. In some embodiments, the receiver electronic wallet module 122D and its functions described herein may be incorporated as one or more modules of the receiver computer system 106. In other embodiments, the receiver electronic wallet module 122D and its functions described herein may be incorporated as one or more sub-modules of the payment network system 114.

In some embodiments, a module of the receiver computer system 106 may receive user payment data from other components of the system 100 to facilitate P2P payments. For example, one or more of the receiver operating system 122A, receiver browser module 122B, receiver communication module 122C, and receiver electronic wallet module 122D may receive data to a financial institution system 108, the gateway system 110, and/or to the payment network system 114 to complete a P2P payment transaction between the sender computer system 104 and the receiver computer system 106. Data received by the receiver computer system 106 from other components of the system may include a sender name, a sender amount, financial institution system account data 165A, sender and/or receiver identification data, and other data. The receiver computer system may not be indicated within the account data 165A of the financial institution system 108.

The financial institution system 108 may include a computing device such as a financial institution server 130 including a processor 132 and memory 134 including components to receive instructions 117 from the sender computer system 104 to facilitate sending a payment to the receiver computer system. The instructions 117 from the sender computer system 104 may include a value and identifying information for the receiver computer system 106. For example, the identifying information may include an email address, a telephone number, a physical address, a MAC address, an IP address, an account identification, or other data that may allow the system 100 to provision a virtual or physical debit card to the receiver computer system 106. In some embodiments, the financial institution server 130 may include one or more modules 136 stored on the memory 134 including instructions that, when executed by the processor 132 receive instructions 117 from the sender computer system 104 and issue instructions 118 to the gateway system 110 to manage issuing and loading a virtual debit card 158A (i.e., an object including the data representing the virtual debit card, as described herein). The various components of the financial institution system 108 may also include instructions to record financial institution system account data 165A corresponding to various sender computer systems 104 and receiver computer systems 106 within a financial institution system account repository 165. The financial institution system account data 165A may include records for the instructions 117 to send payments from a sender computer system 104 corresponding to the financial institution system data 165A (i.e., an account holder with the financial institution) as well as account data (account balances, numbers, addresses, receivers, etc.).

The sender computer system 104 may be indicated in financial institution system account data 165A of the financial institution system 108 while the receiver computer system 106 may not be indicated in the financial institution system account data 165A at the same financial institution system. In other words, the sender and receiver are not members of the same financial institution. Likewise, no peer-to-peer payment system (e.g., PayPal®, Venmo®, Zelle®, GooglePay®, etc.) includes both the sender computer system 104 and the receiver computer system 106 as members.

The gateway system 110 may include a computing device such as a gateway server 140 including a processor 142 and memory 144 including components to receive instructions 118 from the financial institution system 108 to facilitate sending a payment to the receiver computer system 106. In some embodiments, the gateway computer system 110 may be a component of the payment network system 114, or may be a stand-alone component of the system that is remote from the payment network system 114. A gateway module 146 may include instructions to receive the instructions 118 from the financial institution system 108 and, in response to the instructions 118, send further instructions 119 to the prepaid card provider system 112 to provision the virtual debit card 158A. Records 148A of the various instructions from other components of the system 100 and the provisioning of virtual debit cards 158A may be stored by the gateway module 146 within a gateway record repository 148.

The prepaid card provider system 112 may include a computing device such as a prepaid card provider server 150 including a processor 152 and memory 154 including components to receive the further instructions 119 from the gateway system 110. In response, a prepaid card provider module 156 may execute instructions 125 to provision a virtual debit card 158A and store the object 158A within a virtual debit card repository 158.

Upon successful provisioning of the virtual debit card 158A by the prepaid card provider system 112, the instructions 125 may also include further instructions to issue a call to the gateway system 110 generally and to a push to card module 169 of the payment network system 112, in particular. The payment network system 112 may include a computing device such as a payment network server 160 including a processor 162 and memory 164 including a payment network module 166. Records 168A of the various instructions from other components of the system 100 and the push to card transaction instructions from the gateway system 110 may be stored by the payment network module 166 within a transaction repository 168. The push to card module 169 may include an instruction to initiate a push to card transaction 127. The payment network module 166 may also include instructions to load the virtual debit card 158A with a value and other information necessary for the receiver computer system 106 to use the virtual debit card 158A in a payment transaction.

In coordination with the prepaid card provider system 112, the gateway module 146 may also include instructions to send a success message 128 to the financial institution system module 136. Further, the gateway module 146 may include instructions to send a virtual debit card detail message 129 to the receiver computer system including a value and other information necessary for the receiver computer system 106 to use the virtual debit card 158A in a payment transaction. The financial institution system module 136 may also include an instruction to send a success message to the sender computer system 104 indicating that the payment has been sent as well as an instruction to debit an account balance for the amount sent to the receiver computer system. The account balance corresponds to financial institution system account data 165A for the sender computer system 104.

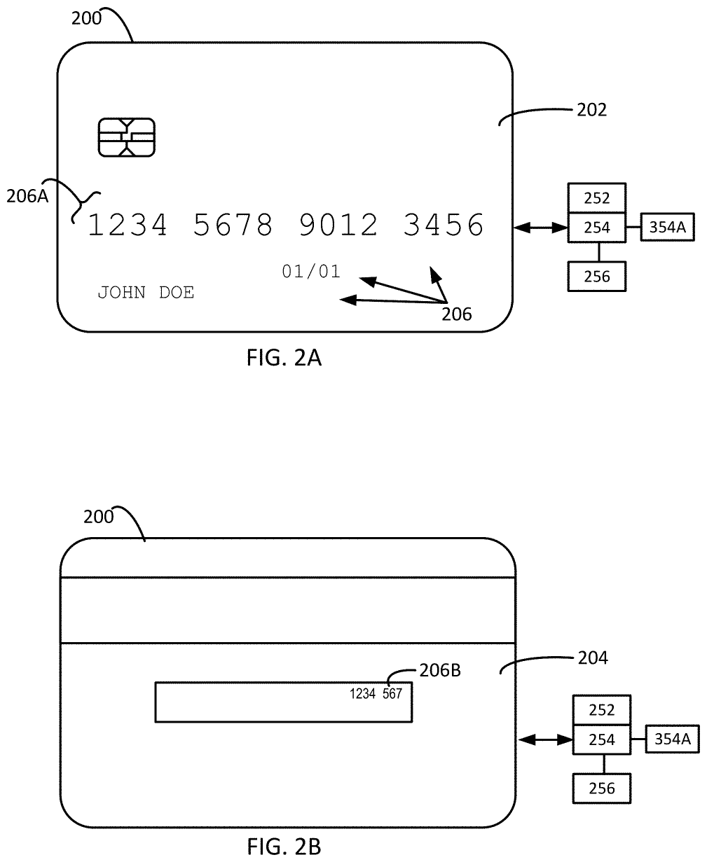

In some embodiments, the virtual debit card 158A may include instructions to integrate the virtual debit card 158A with the receiver electronic wallet module 122D. For example, the gateway module 146 may include instructions to determine an API for the receiver electronic wallet module 122D and further instructions to format the virtual debit card 158A to be compatible with the module 122D. In other embodiments, the gateway module 146 may include instructions to query the receiver computer system 106 to determine a format for the virtual debit card 158A. The format may include a physical payment device 200 (FIGS. 2A and 2B), a virtual debit card 158A that may be deposited into a financial institution account corresponding to the receiver computer system 106, a virtual debit card 158A that may be used with the receiver electronic wallet module 122D, and other physical or virtual currencies.

With brief reference to FIGS. 2A and 2B, an exemplary payment device 200 may take on a variety of shapes and forms. In some embodiments, the payment device 200 is a traditional card such as a debit card or credit card. In other embodiments, the payment device 200 may be a fob on a key chain, an NFC wearable, or other device. In other embodiments, the payment device 200 may be an electronic wallet where one account from a plurality of accounts previously stored in the wallet is selected and communicated to the system 100 to execute the transaction. As long as the payment device 200 is able to communicate securely with the system 100 and its components, the form of the payment device 200 may not be especially critical and may be a design choice. For example, many legacy payment devices may have to be read by a magnetic stripe reader and thus, the payment device 200 may have to be sized to fit through a magnetic card reader. In other examples, the payment device 200 may communicate through near field communication and the form of the payment device 200 may be virtually any form. Of course, other forms may be possible based on the use of the card, the type of reader being used, etc.

Physically, the payment device 200 may be a card and the card may have a plurality of layers to contain the various elements that make up the payment device 200. In one embodiment, the payment device 200 may have a substantially flat front surface 202 and a substantially flat back surface 204 opposite the front surface 202. Logically, in some embodiments, the surfaces 202, 204 may have some embossments 206 or other forms of legible writing including a personal account number (PAN) 206A and the card verification number (CVN) 206B. In some embodiments, the payment device 200 may include data corresponding to the primary account holder, such as payment network account data 164A for the account holder. A memory 254 generally and a module 254A in particular may be encrypted such that all data related to payment is secure from unwanted third parties. A communication interface 256 may include instructions to facilitate sending payment data 143B, 143A such as a payment payload, a payment token, or other data to identify payment information to one or more components of the system 100 via the network 102.

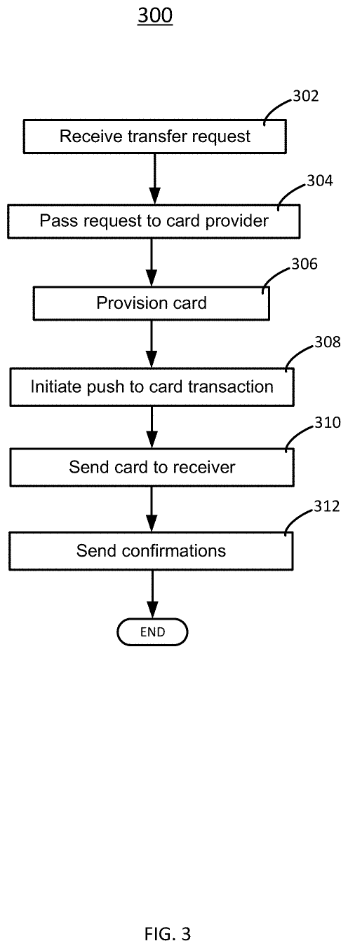

FIG. 3 is a flowchart of a method 300 for facilitating payments using virtual and physical debit cards between individuals and merchants. Each step of the method 300 is one or more computer-executable instructions performed on a server or other computing device which may be physically configured to execute the different aspects of the method. Each step may include execution of any of the instructions as described in relation to the system 100. While the below blocks are presented as an ordered set, the various steps described may be executed in any particular order to complete the peer-to-peer payment methods described herein.

At block 302, the method 300 may cause a processor of the system to receive instructions 117 from the sender computer system 104 to facilitate sending a payment to the receiver computer system 106. The sender computer system may be indicated in financial institution system account data 165A of the financial institution system 108 while the receiver computer system 106 may not be indicated in the financial institution system account data 165A at the same financial institution system. In other words, the sender and receiver are not members of the same financial institution. Likewise, no peer-to-peer payment system (e.g., PayPal®, Venmo®, Zelle®, GooglePay®, etc.) includes both the sender computer system 104 and the receiver computer system 106 as members. The instructions 117 from the sender computer system 104 may include a value and identifying information for the sender computer system 104 and the receiver computer system 106. In some embodiments, a processor of the sender computer system 104 may execute further instructions to send the instructions 117 to one or more of the financial institution system 108, the gateway system 110, or the payment network system 114, as described herein.

At block 304, the method 300 may cause a processor of the system 100 to pass some or all of the instructions 117 received at block 302 to a prepaid card provider system 112. Using the instructions 117, a processor of the prepaid card provider system 112 may execute instructions to provision a virtual debit card 158A at block 306 and to initiate a push to card transaction at block 308. In some embodiments, the gateway system 110 may receive an indication from the prepaid card provider system 112 that the virtual debit card 158A was created. The push to card transaction may be completed by a processor of the payment network system 114 by loading a value and other information sent by the sender computer system in the instructions 117 onto the virtual debit card 158A.

At block 310, the method 300 may cause a processor of the system 100 to send a virtual debit card detail message 129 to the receiver computer system 106 including the loaded virtual debit card 158A and other information necessary for the receiver computer system 106 to use the virtual debit card 158A in a payment transaction. As described herein, in some embodiments, the block 310 may also cause a processor of the system 100 to integrate some or all of the data included in the virtual debit card detail message 129 into the receiver electronic wallet module 122D of the receiver computer system 106. In further embodiments, the block 310 may cause a processor of the system 100 to send a physical debit card (e.g., a payment device 200) to a physical address corresponding to the receiver computer system 106.

At block 312, the method 300 may cause a processor of the system 100 to send various confirmation messages to the components of the system 100. For example, a processor may execute an instruction of the financial institution system module 136 to send a success message to the sender computer system 104 indicating that the payment has been sent as well as an instruction to debit an account balance for the amount sent to the receiver computer system 106. The account balance may correspond to financial institution system account data 165A for the sender computer system 104.

Thus, the present disclosure provides a technical solution to the technical problem of implementing a P2P payment system without the need for both the sender and receiver to have accounts with the same financial institution, the same P2P payments provider, or banks on the same network. The disclosed system 100 improves past P2P payment systems by employing virtual debit cards as the vehicle for sending money to anyone with an email address or cellular phone number. Too, by integrating the disclosed solution with a receiver's electronic wallet at the receiver's cellular phone, a virtual debit card may be used as readily as cash and immediately upon receipt rather than relying on receipt of a cashier's check or a wire service, as can only be done in current P2P payment systems.

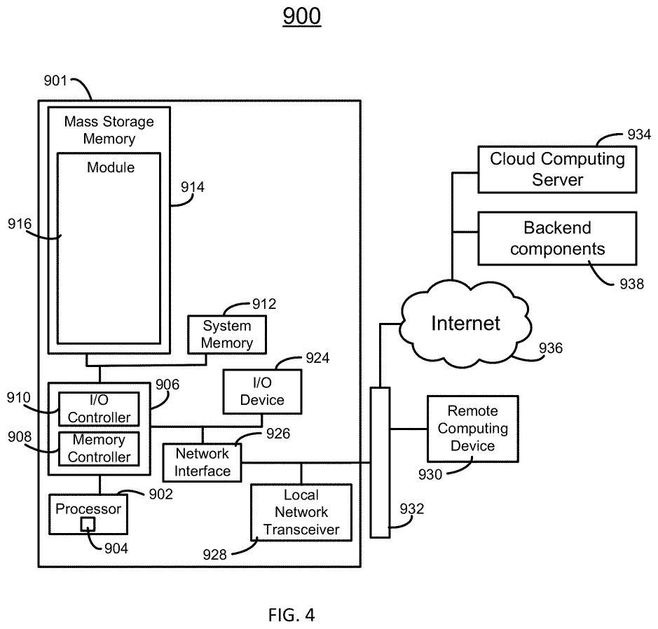

FIG. 4 is a high-level block diagram of an example computing environment 900 for the system 100 and methods (e.g., method 300) as described herein. The computing device 900 may include a server (e.g., the sender computer system 104, the receiver computer system 106, the financial institution server 130, the prepaid card provider server 150, the gateway server 140, the payment network server 160, etc.), a mobile computing device (e.g., sender computer system 104, receiver computer system 106), a tablet computer, a Wi-Fi-enabled device or other personal computing device capable of wireless or wired communication), a thin client, or other known type of computing device.

Logically, the various servers may be designed and built to specifically execute certain tasks. For example, the payment network 160 may receive a large amount of data in a short period of time meaning the payment network server may contain a special, high speed input output circuit to handle the large amount of data. Similarly, the gateway server 140 may execute processor-intensive modules and thus the server 140 may have increased processing power that is specially adapted to quickly execute certain algorithms.

As will be recognized by one skilled in the art, in light of the disclosure and teachings herein, other types of computing devices can be used that have different architectures. Processor systems similar or identical to the example systems and methods described herein may be used to implement and execute the example systems and methods described herein. Although the example system 100 is described below as including a plurality of peripherals, interfaces, chips, memories, etc., one or more of those elements may be omitted from other example processor systems used to implement and execute the example systems and methods. Also, other components may be added.

As shown in FIG. 4, the computing device 901 includes a processor 902 that is coupled to an interconnection bus. The processor 902 includes a register set or register space 904, which is depicted in FIG. 4 as being entirely on-chip, but which could alternatively be located entirely or partially off-chip and directly coupled to the processor 902 via dedicated electrical connections and/or via the interconnection bus. The processor 902 may be any suitable processor, processing unit or microprocessor. Although not shown in FIG. 4, the computing device 901 may be a multi-processor device and, thus, may include one or more additional processors that are identical or similar to the processor 902 and that are communicatively coupled to the interconnection bus.

The processor 902 of FIG. 4 is coupled to a chipset 906, which includes a memory controller 908 and a peripheral input/output (I/O) controller 910. As is well known, a chipset typically provides I/O and memory management functions as well as a plurality of general purpose and/or special purpose registers, timers, etc. that are accessible or used by one or more processors coupled to the chipset 906. The memory controller 908 performs functions that enable the processor 902 (or processors if there are multiple processors) to access a system memory 912 and a mass storage memory 914, that may include either or both of an in-memory cache (e.g., a cache within the memory 912) or an on-disk cache (e.g., a cache within the mass storage memory 914).

The system memory 912 may include any desired type of volatile and/or non-volatile memory such as, for example, static random access memory (SRAM), dynamic random access memory (DRAM), flash memory, read-only memory (ROM), etc. The mass storage memory 914 may include any desired type of mass storage device. For example, the computing device 901 may be used to implement a module 916 (e.g., the various modules as herein described). The mass storage memory 914 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 901, the systems and methods described herein. Thus, a module, block, function, operation, procedure, routine, step, and method can be implemented in hardware, firmware, and/or software. In one embodiment, program modules and routines are stored in mass storage memory 914, loaded into system memory 912, and executed by a processor 902 or can be provided from computer program products that are stored in tangible computer-readable storage mediums (e.g. RAM, hard disk, optical/magnetic media, etc.).

The peripheral I/O controller 910 performs functions that enable the processor 902 to communicate with a peripheral input/output (I/O) device 924, a network interface 926, a local network transceiver 928, (via the network interface 926) via a peripheral I/O bus. The I/O device 924 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 924 may be used with the module 916, etc., to receive data from the transceiver 928, send the data to the components of the system 100, and perform any operations related to the methods as described herein. The local network transceiver 928 may include support for a Wi-Fi network, Bluetooth, Infrared, cellular, or other wireless data transmission protocols. In other embodiments, one element may simultaneously support each of the various wireless protocols employed by the computing device 901. For example, a software-defined radio may be able to support multiple protocols via downloadable instructions. In operation, the computing device 901 may be able to periodically poll for visible wireless network transmitters (both cellular and local network) on a periodic basis. Such polling may be possible even while normal wireless traffic is being supported on the computing device 901. The network interface 926 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 908 and the I/O controller 910 are depicted in FIG. 4 as separate functional blocks within the chipset 906, the functions performed by these blocks may be integrated within a single integrated circuit or may be implemented using two or more separate integrated circuits. The computing environment 900 may also implement the module 916 on a remote computing device 930. The remote computing device 930 may communicate with the computing device 901 over an Ethernet link 932. In some embodiments, the module 916 may be retrieved by the computing device 901 from a cloud computing server 934 via the Internet 936. When using the cloud computing server 934, the retrieved module 916 may be programmatically linked with the computing device 901. The module 916 may be a collection of various software platforms including artificial intelligence software and document creation software or may also be a Java® applet executing within a Java® Virtual Machine (JVM) environment resident in the computing device 901 or the remote computing device 930. The module 916 may also be a “plug-in” adapted to execute in a web-browser located on the computing devices 901 and 930. In some embodiments, the module 916 may communicate with back end components 938 via the Internet 936.

The system 900 may include but is not limited to any combination of a LAN, a MAN, a WAN, a mobile, a wired or wireless network, a private network, or a virtual private network. Moreover, while only one remote computing device 930 is illustrated in FIG. 4 to simplify and clarify the description, it is understood that any number of client computers are supported and can be in communication within the system 900.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer-implemented method of facilitating peer-to-peer payments between remote computing systems, the method comprising:
receiving instructions from a sender computer system to facilitate sending a payment to a receiver computer system, wherein the instructions include a value and identifying information for both the sender computer system and the receiver computer system, the sender computer system is indicated in account data at a financial institution system and the receiver computer system is not indicated in the account data at the financial institution system, and no peer-to-peer payment system includes both the sender computer system and the receiver computer system;
provisioning a virtual debit card including identifying information for the receiver computer system;
adding the value to the virtual debit card; and
sending the virtual debit card to the receiver computer system.

2. The method of claim 1, wherein adding the value to the virtual debit card includes initiating a push to card transaction with the virtual debit card.

3. The method of claim 2, further comprising sending a confirmation message to the sender computer system upon sending the virtual debit card to the receiver computer system.

4. The method of claim 3, wherein sending the virtual debit card to the receiver computer system includes sending a virtual debit card detail message to the receiver computer system.

5. The method of claim 4, wherein adding the value to the virtual debit card includes debiting an account balance of the account data at the financial institution system.

6. The method of claim 5, wherein the account data corresponds to the sender computer system.

7. The method of claim 6, further comprising determining an API for a receiver electronic wallet module.

8. The method of claim 7, wherein the virtual debit card detail message includes instructions to integrate the virtual debit card with the receiver electronic wallet module.

9. The method of claim 8, further comprising integrating the virtual debit card into a receiver electronic wallet module at the receiver computer system.

10. The method of claim 9, wherein the virtual debit card detail message further includes instructions to receive a physical debit card.

11. A system for facilitating peer-to-peer payments between remote computing systems, the system comprising:
a first processor and a first memory hosting a gateway system, wherein the first memory includes instructions that are executable by the first processor for:
receiving instructions to facilitate sending a payment from a sender computer system to a receiver computer system, wherein the instructions include a value and identifying information for both the sender computer system and the receiver computer system, the sender computer system is indicated in account data at a financial institution system and the receiver computer system is not indicated in the account data at the financial institution system, and no peer-to-peer payment system includes both the sender computer system and the receiver computer system;
a second processor and a second memory hosting a payment network system, wherein the second memory includes instructions that are executable by the second processor for:
provisioning a virtual debit card including identifying information for the receiver computer system;
adding the value to the virtual debit card; and
sending the virtual debit card to the receiver computer system.

12. The system of claim 11, wherein the instructions for adding the value to the virtual debit card includes an instruction for initiating a push to card transaction with the virtual debit card.

13. The system of claim 12, wherein the second memory includes a further instruction for sending a confirmation message to the sender computer system upon sending the virtual debit card to the receiver computer system.

14. The system of claim 13, wherein the instructions for sending the virtual debit card to the receiver computer system includes an instruction for sending a virtual debit card detail message to the receiver computer system.

15. The system of claim 14, wherein the instructions for adding the value to the virtual debit card includes an instruction for debiting an account balance of the account data at the financial institution system.

16. The system of claim 15, wherein the account data corresponds to the sender computer system.

17. The system of claim 16, wherein the second memory includes a further instruction for determining an API for a receiver electronic wallet module.

18. The system of claim 17, wherein the virtual debit card detail message includes instructions to integrate the virtual debit card with the receiver electronic wallet module.

19. The system of claim 18, wherein the second memory includes a further instruction for integrating the virtual debit card into a receiver electronic wallet module at the receiver computer system.

20. The system of claim 19, wherein the virtual debit card detail message further includes instructions to receive a physical debit card.
